(19) United States
(12) Patent Application Publication
(10) Pub. No.: US 2014/0379439 A1
(43) Pub. Date: Dec. 25, 2014

(54) AGGREGATION OF SUBSETS OF OPINIONS FROM GROUP COLLABORATIONS

(71) Applicant: International Business Machines Corporation, Armonk, NY (US)

(72) Inventor: Vivek Sekhar, San Francisco, CA (US)

(21) Appl. No.: 14/480,702

(22) Filed: Sep. 9, 2014

Related U.S. Application Data
(63) Continuation of application No. 11/366,517, filed on Mar. 2, 2006.

(30) Foreign Application Priority Data
Oct. 28, 2005 (CA) 2525267

(51) Int. Cl. G06Q 10/10

(52) U.S. Cl. CPC G06Q 10/10; G06Q 2230/00
USPC 705/12

(57) ABSTRACT

A method and system for aggregating opinions on questions from participants. The selection of a category is received from each participant for each question previously presented to each participant. The selection is a category into which each participant has placed an idea associated with each question. A percentage vote, which is calculated for each selected category of each idea, is a percent of participants that selected each category of each idea. A winning category is selected for each idea, based on the calculated percentage vote for each selected category of each idea. A next idea, consisting of the idea having the lowest calculated percentage vote of the ideas's winning category, is determined. A next question associated with the next idea having the lowest calculated percentage vote of the ideas's winning category is determined and presented to a new participant.

This application is a continuation application claiming priority to Ser. No. 11/366,517, filed Mar. 2, 2006.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND OF THE INVENTION

The present invention relates to systems, methods and tools for collecting opinions, in particular from group collaborations.

Technology-assisted group collaborations are now commonplace: many types of tools have been created to support and to expand upon the scope of what can be accomplished between geographically dispersed participants. Some of these tools may permit the collection of opinions from a large group of people, often using an online poll format where a series of questions are presented to participants. This technique may be scalable with respect to the number of poll participants, but is not necessarily scalable with respect to the number of questions, or length of time necessary for each participant to express their opinions. Often, there may be tight constraints on how many and what kind of questions can be asked in a poll. An example of a poll that might be unwieldy in this way may be one in which members of the public are asked for their opinions on a variety of ideas to implement a new program on recycling. There could be dozens, hundreds, or perhaps thousands of ideas. In such a case, no respondent may be reasonably be expected to express an opinion on every one of the ideas.

What is needed is a way to more efficiently collect an opinion from a large group of participants.

### SUMMARY OF THE INVENTION

The present invention relates to systems, method and tools for aggregating subsets of opinions from group collaborations.

In an embodiment, each participant may be asked to answer a small subset of questions, where each subset of questions presented to a participant may be different from a subset of questions posed to another participant. Data processing system implemented methods, systems and tools may be used to prepare each subset of questions to be asked, based on which questions require a larger sample of opinions, and to aggregate the subsets of opinions to infer an aggregate opinion for the group. This may significantly reduce or eliminate the need to subject a participant to the onerous task of expressing an opinion on each one of a large number of questions that may be collected in a group collaboration.

In an aspect of the invention, there is provided a data processing system implemented method of aggregating opinions on a plurality of questions from a plurality of participants, comprising: providing to each participant a question, and requiring for each question an opinion from the participant that may be expressed as a numeric value; for each question, aggregating opinions received from the participants, and calculating a mean value representative of an aggregated opinion of the participants; for each question, from the distribution of numeric values of the received opinions, calculating a measure of confidence in the aggregated opinion; for a successive participant, providing a question selected in dependence upon the calculated measure of confidence in the aggregated opinion.

In an embodiment, the method further comprises ranking questions in dependence upon their calculated measures of confidence, and selecting a question to be posed to a successive participant from the ranked questions, with a preference for questions having a lower confidence value.

In another embodiment, the method further comprises, given a number of questions having the same measures of confidence, randomly selecting a question from amongst these number of questions for posing to a successive participant.

In another embodiment, the measure of confidence for each question is a confidence interval calculated from the distribution of numeric values of the received opinions.

In another embodiment, the method further comprises: ranking the questions based on their aggregated opinions; selecting a region of interest in the ranked list of questions; and selecting a question to be posed to a successive participant from the region of interest with a preference for questions having a wider confidence interval.

In yet another embodiment, the method further comprises posing questions to successive participants until the confidence intervals for the questions in the region of interest have reached a desired confidence interval.

In another embodiment, the method further comprises: providing a number of predefined categories, and requiring from each participant an opinion as to which category a question belongs; and for each question, tabulating the number of participants selecting each category of the predefined categories, and calculating a percentage vote for each category.

In yet another embodiment, the method further comprises, for each question, selecting a winning category based on the calculated percentage votes, and ranking the questions in dependence upon the calculated percentage votes in the winning category.

In another embodiment, the method further comprises preferentially selecting a question having the lowest percentage vote in the winning category for posing to a successive participant.

In another aspect of the invention, there is provided a data processing system for aggregating opinions on a plurality of questions from a plurality of participants, comprising: means for providing to each participant a question, and requiring for each question an opinion from the participant that may be expressed as a numeric value; means for aggregating, for each question, opinions received from the participants, and calculating a mean value representative of an aggregated opinion of the participants; means for calculating for each question, from the distribution of numeric values of the received opinions for the question, a measure of confidence in the aggregated opinion; and means for providing, for a successive participant, a question selected in dependence upon the calculated measure of confidence in the aggregated opinion.

In an embodiment, the system further comprises means for ranking questions in dependence upon their calculated measures of confidence, and selecting a question to be posed to a successive participant from the ranked questions, with a preference for questions having a lower confidence value.

In another embodiment, the system further comprises means for randomly selecting a question, from amongst a number of questions having the same measures of confidence, for posing to a successive participant.

In another embodiment, the measure of confidence for each question is a confidence interval calculated from the distribution of numeric values of the received opinions.

In another embodiment, the system further comprises: means for ranking the questions based on their aggregated opinions; means for selecting a region of interest in the ranked list of questions; and means for selecting a question to be posed to a successive participant from the region of interest with a preference for questions having a wider confidence interval.

In still another embodiment, the system further comprises means for posing questions to successive participants until the confidence intervals for the questions in the region of interest have reached a desired confidence interval.

In an embodiment, the system further comprises means for providing a number of predefined categories, and requiring from each participant an opinion as to which category a question belongs; means for tabulating, for each question, the number of participants selecting each category of the predefined categories, and calculating a percentage vote for each category.

In an embodiment, the system further comprises means for selecting, for each question, a winning category based on the calculated percentage votes, and ranking the questions in dependence upon the calculated percentage votes in the winning category.

In an embodiment, the system further comprises means for preferentially selecting a question having the lowest percentage vote in the winning category for posing to a successive participant.

In another aspect of the invention, there is provided a data processor readable medium for storing data processor code that, when loaded into a data processing device, adapts the device to aggregate opinions on a plurality of questions from a plurality of participants, the data processor readable medium including: code for providing to each participant a question, and requiring for each question an opinion from the participant that may be expressed as a numeric value; code for aggregating, for each question, opinions received from the participants, and calculating a mean value representative of an aggregated opinion of the participants; code for calculating for each question, from the distribution of numeric values of the received opinions for the question, a measure of confidence in the aggregated opinion; code for providing, for a successive participant, a question selected in dependence upon the calculated measure of confidence in the aggregated opinion.

In an embodiment, the data processor readable medium further includes code for ranking questions in dependence upon their calculated measures of confidence, and selecting a question to be posed to a successive participant from the ranked questions, with a preference for questions having a lower confidence value.

In another embodiment, the data processor readable medium further includes code for randomly selecting a question, from amongst a number of questions having the same measures of confidence, for posing to a successive participant.

In another embodiment, the measure of confidence for each question is a confidence interval calculated from the distribution of numeric values of the received opinions.

In another embodiment, the data processor readable medium further includes: code for ranking the questions based on their aggregated opinions; code for selecting a region of interest in the ranked list of questions; and code for selecting a question to be posed to a successive participant from the region of interest with a preference for questions having a wider confidence interval.

In still another embodiment, the data processor readable medium further includes code for posing questions to successive participants until the confidence intervals for the questions in the region of interest have reached a desired confidence interval.

In another embodiment, the data processor readable medium further includes: code for providing a number of predefined categories, and requiring from each participant an opinion as to which category a question belongs; code for tabulating, for each question, the number of participants selecting each category of the predefined categories, and calculating a percentage vote for each category.

In another embodiment, the data processor readable medium further includes code for selecting, for each question, a winning category based on the calculated percentage votes, and ranking the questions in dependence upon the calculated percentage votes in the winning category.

In still another embodiment, the data processor readable medium further includes code for preferentially selecting a question having the lowest percentage vote in the winning category for posing to a successive participant.

These and other aspects of the invention will become apparent from the following more particular descriptions of exemplary embodiments.

### BRIEF DESCRIPTION OF THE DRAWINGS

In the figures which illustrate exemplary embodiments of the invention:

FIG. 1 shows a generic data processing system that may provide a suitable operating environment.

FIG. 2A and FIG. 2B show an illustrative framework for policy development.

FIG. 3A and FIG. 3B show illustrative schematic views of an idea tree.

FIG. 3C shows an illustrative data schema for the idea tree of FIG. 3A and FIG. 3B.

FIG. 4A shows an illustrative screen capture of a brainstorm chat tool.

FIG. 4B shows an illustrative screen capture of a categorizer tool.

FIG. 4C shows an illustrative screen capture of a collaborative document editing tool.

FIG. 4D shows an illustrative screen capture of a real-time collaborative document editing tool.

FIG. 4E shows an illustrative screen capture of a document commenting tool.

FIG. 4F shows an illustrative screen capture of a ranking tool.

FIG. 4G shows an illustrative screen capture of a solution matrix tool.

FIG. 5 shows a schematic diagram of an illustrative IT architecture for the tools.

FIG. 6 shows a schematic diagram of an illustrative communication flow between some components of the IT architecture of FIG. 5.

FIG. 7A shows an illustrative initial ranking of ideas and an associated confidence interval.

FIG. 7B shows an illustrative ranking of ideas and an associated confidence interval after participants have contributed opinions with respect to some of the ideas.

FIG. 7C shows an illustrative categorization of ideas ranked in 7B.

### DETAILED DESCRIPTION OF THE PREFERRED EMBODIMENT

The present invention relates to systems, methods and tools for aggregating subsets of opinions from group collaborations.

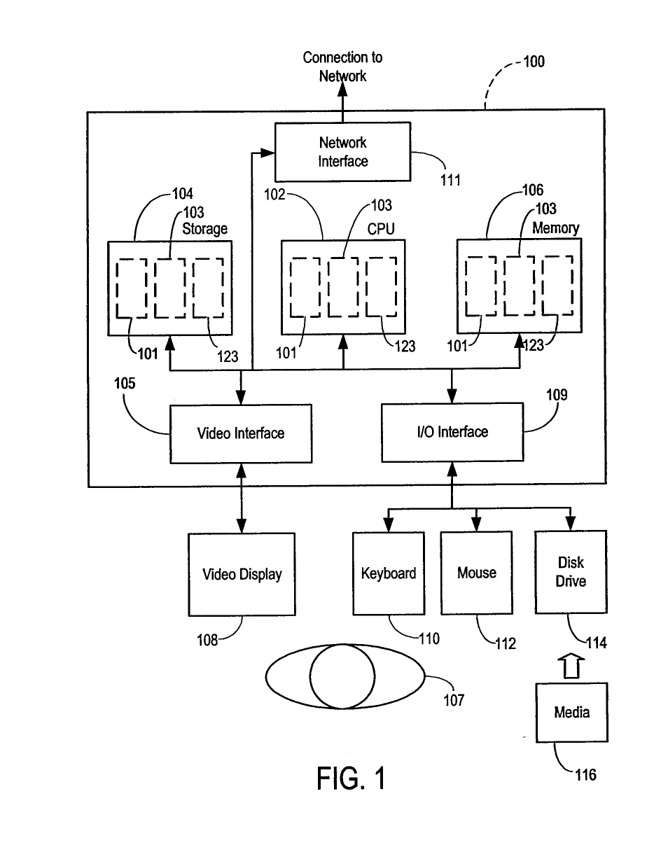

The invention may be practiced in various embodiments. A suitably configured data processing system, and associated communications networks, devices, software and firmware may be provided to provide a platform for enabling one or more of these systems, methods, and tools. By way of example, FIG. 1 shows a generic data processing system 100 that may include a central processing unit (“CPU”) 102 connected to a storage unit 104 and to a random access memory 106. The CPU 102 may process an operating system 101, application program 103, and data 123. The operating system 101, application program 103, and data 123 may be stored in storage unit 104 and loaded into memory 106, as may be required. An operator 107 may interact with the data processing system 100 using a video display 108 connected by a video interface 105, and various input/output devices such as a keyboard 110, mouse 112, and disk drive 114 connected by an I/O interface 109. In known manner, the mouse 112 may be configured to control movement of a cursor in the video display 108, and to operate various graphical user interface (“GUI”) controls appearing in the video display 108 with a mouse button. The disk drive 114 may be configured to accept data processing system readable media 116. The data processing system 100 may form part of a network via a network interface 111, allowing the data processing system 100 to communicate with other suitably configured data processing systems (not shown). The particular configurations shown by way of example in this specification are not meant to be limiting.

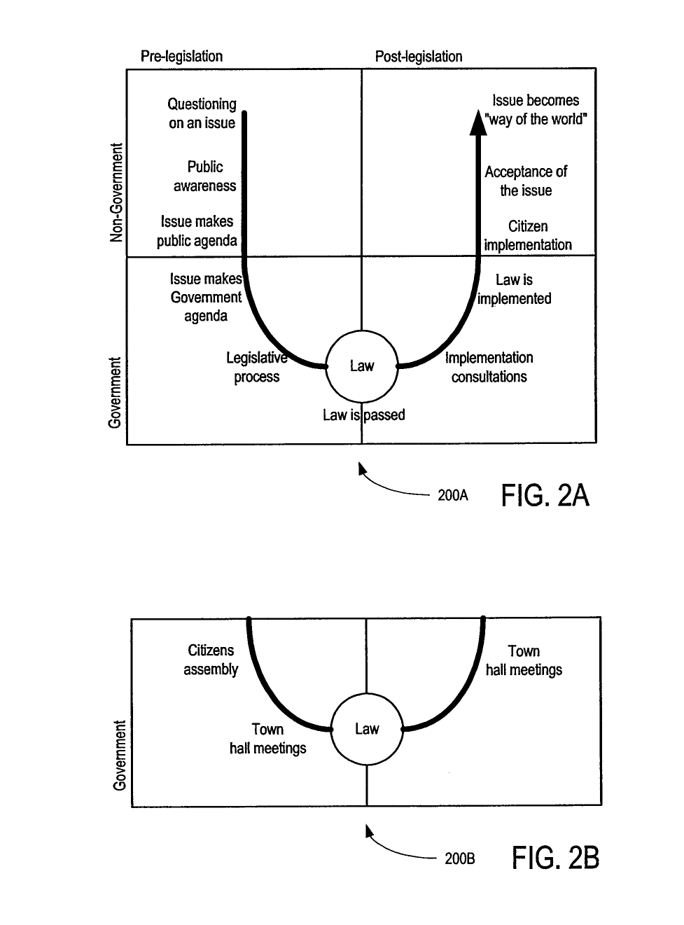

Aggregating subsets of opinions from many different types of group collaboration projects may be facilitated by the present invention. By way of illustration, one such group collaboration project may involve citizen engagement in a public policy making process. In FIG. 2A, shown is a typical policy making framework representing a timeline from the original idea to long-term implementation. In this framework, the timeline is partitioned into four quadrants, with the top two quadrants representing citizen-led actions, and the bottom two quadrants representing government-led actions. The left side quadrants represent pre-legislative events, while the right side quadrants represent post-legislative events. Within this policy making framework, citizens may introduce, debate and question a policy, and depending on the input and feedback, the government may decide whether or not to implement the policy through a legislative process.

As shown in FIG. 2B, in the bottom half of the framework, government-led initiatives such as town hall meetings, citizens' assemblies, and citizens' juries may provide a forum for input from citizens. However, these citizens' juries and town hall meetings may tend to provide only a limited opportunity for citizen participation. They may not allow the government to take advantage of a full range of input and opinions from a more representative sample of the voting population. Given the potential size and range of opinions that may result, this illustrative application demonstrates a need for the solutions taught by the present invention.

The invention will now be explained in the context of an illustrative environment in which the invention may be practiced, although this illustrative environment is not meant to be limiting. More generally, the present invention may be practiced in the context of a solution proposed by the inventors for facilitating collaboration amongst a large group of people, for which a co-pending application has been filed as noted above.

A solution for facilitating large-scale group collaboration may include the following: (i) a system and data architecture that allows for the flexible storage, retrieval and manipulation of ideas presented in a variety of forms and formats; and (ii) a collaboration toolkit that enables flexible application of a variety of transformations on the system and data architecture.

The collaboration toolkit, as developed and envisioned by the inventors, provides a set of tools to assist participants and moderators in the process of brainstorming, discussing, and compiling the participants' contributions into a structured and meaningful output. As will be explained in more detail further below, a notable feature of the collaboration toolkit is that tools may be applied to different parts of the data structure at the same time. The tools may also be sequenced for use on the data structure in any order, allowing for the creation of flexible, customized workflows to model virtually any type of collaborative process. Tasks may be split into manageable portions, and contributions from many participants may be integrated into a unified whole. To enable this flexibility, the collaboration toolkit should be used with a data structure that is extensible, flexibly structured, and resilient to error. Given this criteria, the data structure preferred by the inventors is a hierarchical data structure capable of storing heterogeneous data items, and more preferably a modified tree data structure referred to herein as an “idea tree” and as described below.

### The Idea Tree

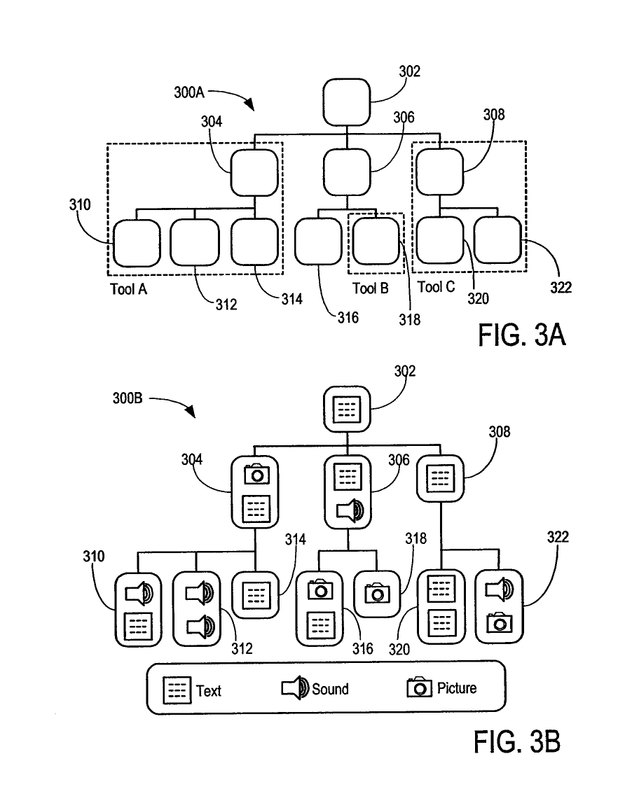

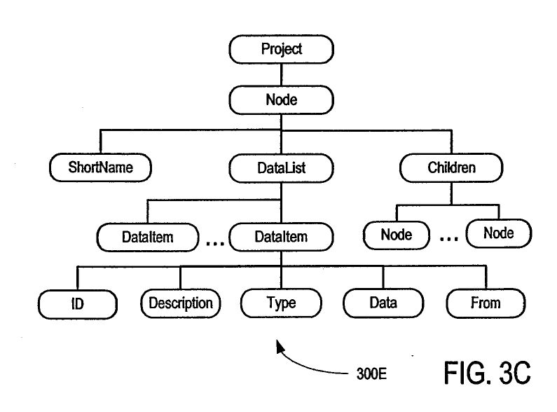

The inventors have selected a tree data structure as illustrated in FIG. 3A, as being well suited for facilitating large-scale collaborations as in the public policy development example introduced above.

As illustrated in FIG. 3A, each “idea tree” 300A starts as a single node, called the root node 302. Using one of the tools in the collaboration toolkit, related ideas or sub-ideas may be added to the idea tree by creating and adding suitable child nodes 304, 306, 308 connected to the root node 302. Each of the sibling nodes 304, 306, 308 may be a parent node having their own child nodes (e.g. parent node 304 has child nodes 310, 312, 314; parent node 306 has child nodes 316, 318; parent node 308 has child nodes 320, 322). Each node in the idea tree may have virtually an unlimited number of child nodes representing sub-ideas, or comments related to the idea expressed in the parent node. As shown in FIG. 3A, a sub-tree of the idea tree may itself be an intact idea tree. This structural self-similarity may permit large-scale collaborations on potentially very broad topics, and may allow multiple collaboration tools to be used on different parts of the idea tree simultaneously. This is illustrated in FIG. 3A where three tools—“Tool A”, “Tool B”, and “Tool C”—are shown acting on different parts of the idea tree 300A. Each of these tools is logically linked to a particular node, and may act upon a “workspace” including the link node and its sub-nodes.

As shown in FIG. 3B, the data storage means associated with each node of the idea tree 300B may store different forms of structured data. As an example, the data storage means associated with each node of idea tree 300B may comprise a table or database having a plurality of records for containing different types of data or information related to a particular node. Each table may be configured to store in its records heterogeneous data items, such as text, sounds, pictures, and various types of information relating to the content or structure of idea tree 300B (e.g. comments on or responses to proposed ideas posted in the form of video clips, texts or sound recordings; results of ratings collected in response to a prompt to rate an idea; hierarchical references to parent nodes and child nodes, etc.).

The data architecture of idea tree 300B may offer considerable flexibility in allowing each collaborative tool to store and to retrieve only the specific pieces of data or information required by the tool, and to ignore the rest. For example, Tool A having a workspace including nodes 304, 310, 312 and 314 may be configured to work only with text data, in which case only the text data in nodes 304, 310 and 314 may be retrieved and used by Tool A. Sound data or picture data in nodes 304, 310, 312, 314 may be ignored by Tool A. As another example, Tool B might be a slideshow tool having a workspace including node 318, and which processes images retrieved from node 318. As yet another example, if this slideshow tool was being used on multiple nodes, the slideshow tool may use ranking information associated with image data stored in the multiple nodes to create a slideshow of images in a ranked order. More examples of tools that may be used on the idea tree are provided further below.

In order to provide data resiliency, the idea tree 300A, 300B may allow any transformation operation performed on the tree to be undone, either by performing one or more reverse transformation operations (for example, by moving an erroneously placed idea to a previous node in the tree), or by allowing the idea tree to revert back to a previously saved state.

The idea tree may be implemented using one of any number of different application development tools and languages. For example, in an Internet-based application development context, the idea tree may be defined using Extensible Markup Language (“XML”). Due to its inherent hierarchical nature, the inventors have found XML to be well suited for defining the idea tree.

In an illustrative example, each node of the idea tree may have a number of defined elements, including a Short Name, Data List, and Children, as listed below in Table A.

TABLE A

| Elements | Description |
|---|---|
| Short Name | A textual description of the node. |
| Data List | Collection of DataItems in the node. |
| Children | List of child nodes connected to this node. |

As well, each DataItem stored on each node may contain a number of pieces of information as shown below in Table B.

TABLE B

| Information | Description |
|---|---|
| ID | A short name that uniquely identifies a piece of |
| | information in the node. |
| Description | A longer, human readable identifier for a piece |
| | of information. |
| Type | Data type of the DataItem (string, integer, rank, |
| | etc.) |
| Data | The data for this DataItem. |
| From | The tool from which this data was created. |

A graphic representation of an illustrative XML schema is shown in FIG. 3E, and a corresponding language version of this XML schema is presented below.

```
<?xml version=“1.0” encoding=“UTF-8”?>
<xs:schema xmlns:xs=“http://www.w3.org/2001/XMLSchema” elementFormDefault=“qualified”
attributeFormDefault=“unqualified”>
  <xs:element name=“Project”>
    <xs:annotation>
      <xs:documentation>An alltogether Toolkit Project - Stores the entire Idea
      Tree</xs:documentation>
    </xs:annotation>
    <xs:complexType>
      <xs:sequence>
        <xs:element name=“Node”>
          <xs:annotation>
            <xs:documentation>A single node in the idea tree.</xs:documentation>
          </xs:annotation>
          <xs:complexType>
            <xs:sequence>
              <xs:element name=“ShortName” nillable=“false”>
                <xs:annotation>
                  <xs:documentation>A short text description of the data within this
                  node.</xs:documentation>
                </xs:annotation>
                <xs:simpleType>
                  <xs:restriction base=“xs:string”>
                    <xs:minLength value=“1”/>
                  </xs:restriction>
                </xs:simpleType>
              </xs:element>
              <xs:element name=“DataList”>
                <xs:annotation>
                  <xs:documentation>A list of all data within this node.
                  </xs:documentation>
                </xs:annotation>
                <xs:complexType>
                  <xs:sequence>
                    <xs:element name=“DataItem” minOccurs=“0”
                    maxOccurs=“unbounded”>
                      <xs:annotation>
                        <xs:documentation>A single piece of data within the
                        node.</xs:documentation>
                      </xs:annotation>
                      <xs:complexType>
                        <xs:sequence>
                          <xs:element name=“ID” nillable=“false”>
                            <xs:annotation>
                              <xs:documentation>A short textual id of
                          the node. This field must be unique
                      within a DataList.</xs:documentation>
                            </xs:annotation>
                            <xs:simpleType>
                              <xs:restriction base=“xs:token”>
                                <xs:minLength value=“1”/>
                              </xs:restriction>
                            </xs:simpleType>
                          </xs:element>
                          <xs:element name=“Description” nillable=“false”>
                            <xs:annotation>
                              <xs:documentation>A human-
                              understandable description
                              of the data stored in the
                              DataItem.</xs:documentation>
                            </xs:annotation>
                            <xs:simpleType>
                              <xs:restriction base=“xs:string”>
                                <xs:minLength value=“1”/>
                              </xs:restriction>
                            </xs:simpleType>
                          </xs:element>
                          <xs:element name=“Type”>
                            <xs:annotation>
                              <xs:documentation>The type of data
                              stored in this DataItem. (E.g. String,
                              Rank, Number)</xs:documentation>
                            </xs:annotation>
                            <xs:simpleType>
                              <xs:restriction base=“xs:token”>
                                <xs:minLength value=“1”/>
                              </xs:restriction>
                            </xs:simpleType>
                          </xs:element>
                          <xs:element name=“Data” nillable=“false”>
                            <xs:annotation>
                              <xs:documentation>The actual
                              data.</xs:documentation>
                            </xs:annotation>
                            <xs:simpleType>
                              <xs:restriction base=“xs:string”>
                                <xs:minLength value=“1”/>
                              </xs:restriction>
                            </xs:simpleType>
                          </xs:element>
                          <xs:element name=“From”>
                            <xs:annotation>
                              <xs:documentation>Which tool this data
                              came from.</xs:documentation>
                            </xs:annotation>
                            <xs:simpleType>
                              <xs:restriction base=“xs:string”>
                                <xs:minLength value=“1”/>
                              </xs:restriction>
                            </xs:simpleType>
                          </xs:element>
                        </xs:sequence>
                      </xs:complexType>
                    </xs:element>
                  </xs:sequence>
                </xs:complexType>
              </xs:element>
              <xs:element name=“Children”>
                <xs:annotation>
                  <xs:documentation>A list of all children of this
                  node.</xs:documentation>
                </xs:annotation>
                <xs:complexType>
                  <xs:sequence>
                    <xs:element ref=“Node” minOccurs=“0”
                    maxOccurs=“unbounded”/>
                  </xs:sequence>
                </xs:complexType>
              </xs:element>
            </xs:sequence>
          </xs:complexType>
        </xs:element>
      </xs:sequence>
    </xs:complexType>
  </xs:element>
  <xs:element name=“Node”/>
</xs:schema>
```

Although the above illustrative XML schema may be suitable for many different kinds of applications, it will be appreciated that the XML schema may be adapted as may be necessary (e.g. to allow for other elements or information descriptors).

### The Collaboration Toolkit

Brief examples of tools that may be used to work on the idea tree were provided earlier. Further examples of tools are now provided.

Generally speaking, the collaboration toolkit may include both participant collaboration tools and moderator tools. In an embodiment, in order to maintain a desired degree of control over the growth of the idea tree, additions and modifications to the idea tree proposed by participants using one of the collaboration tools may be queued, and only applied by a moderator as a transformation on the idea tree at appropriately determined times. Moderator tools, on the other hand, may allow changes to take effect immediately.

In an Internet-based implementation, the collaboration tools may be set up by the moderator and made available on a project's website. An illustrative information technology (IT) architecture is described further below. Participants can enter the website and participate in the group collaboration project using one or more of the available tools. Examples of some collaboration tools are now described:

### (a) Brainstorm Chat Tool

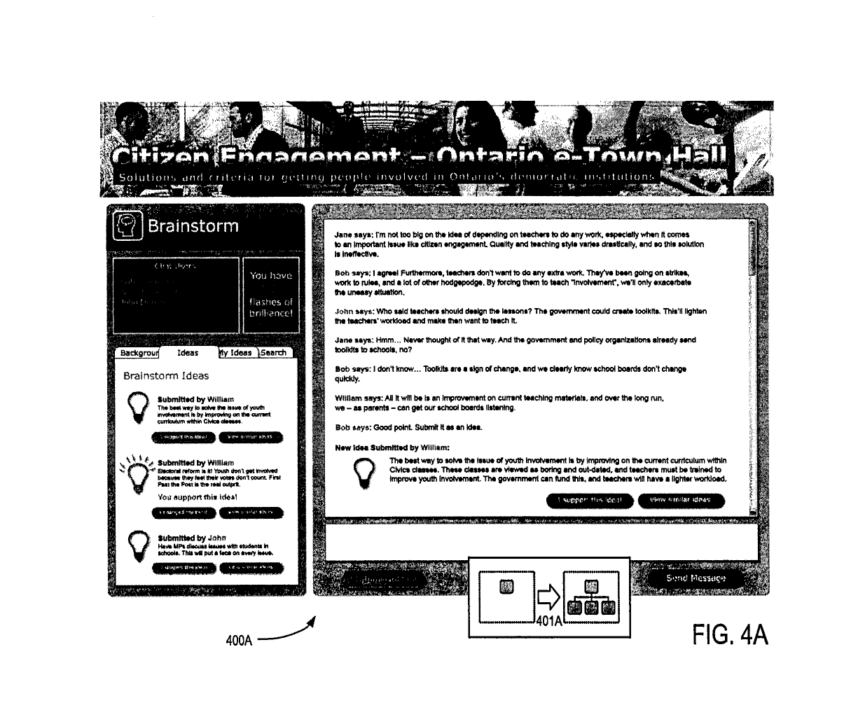

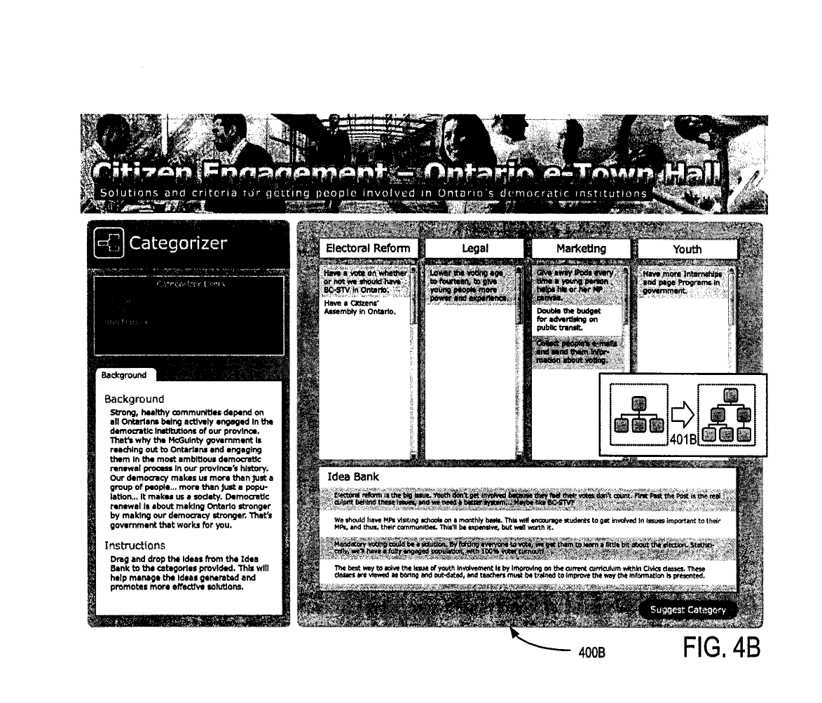

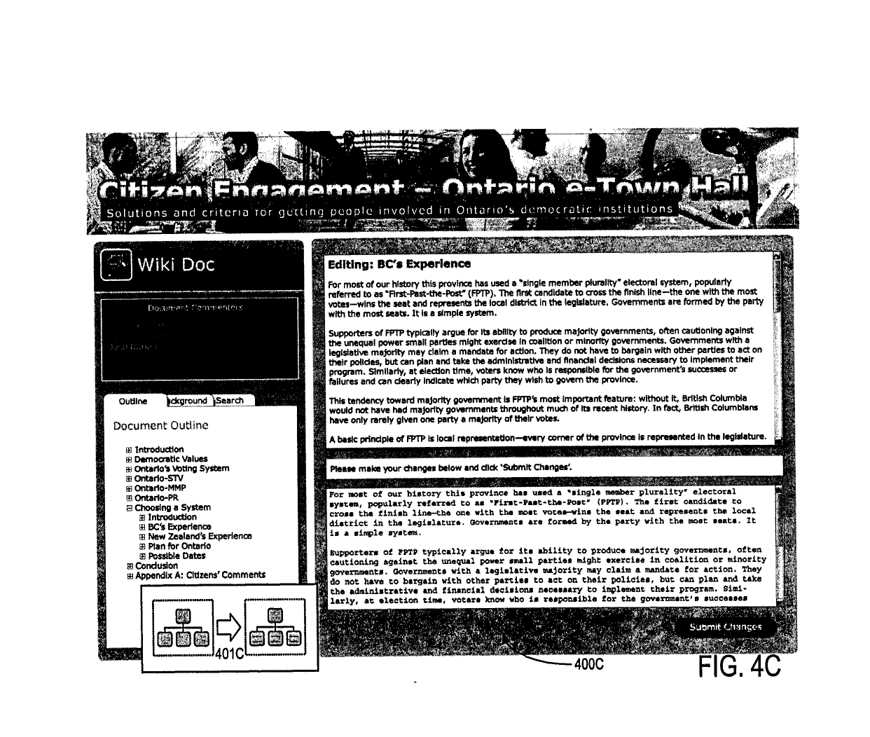

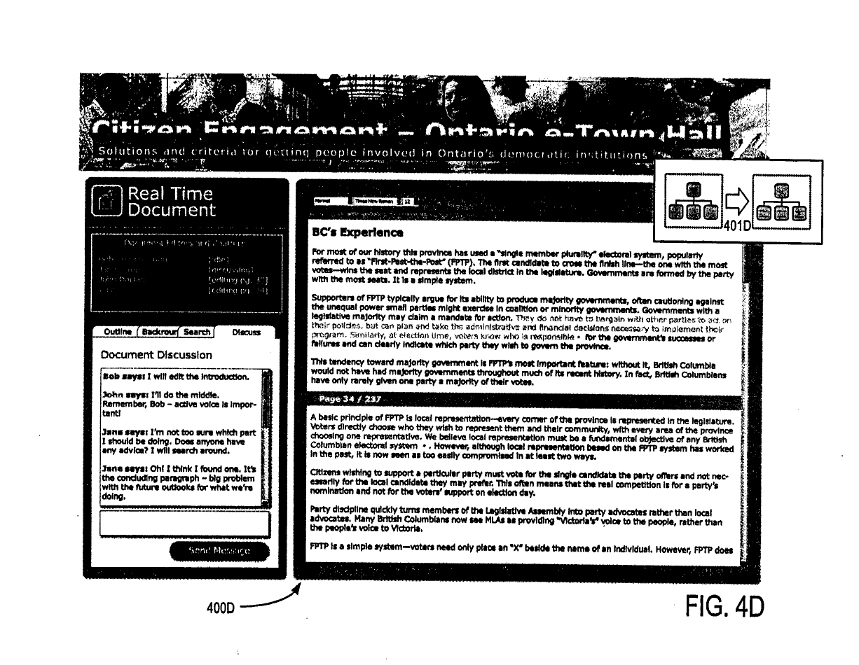

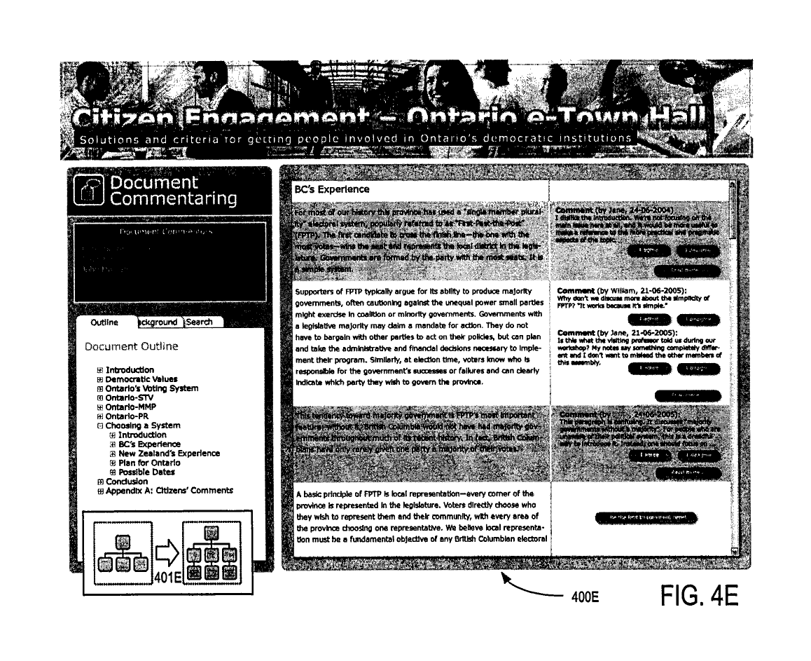

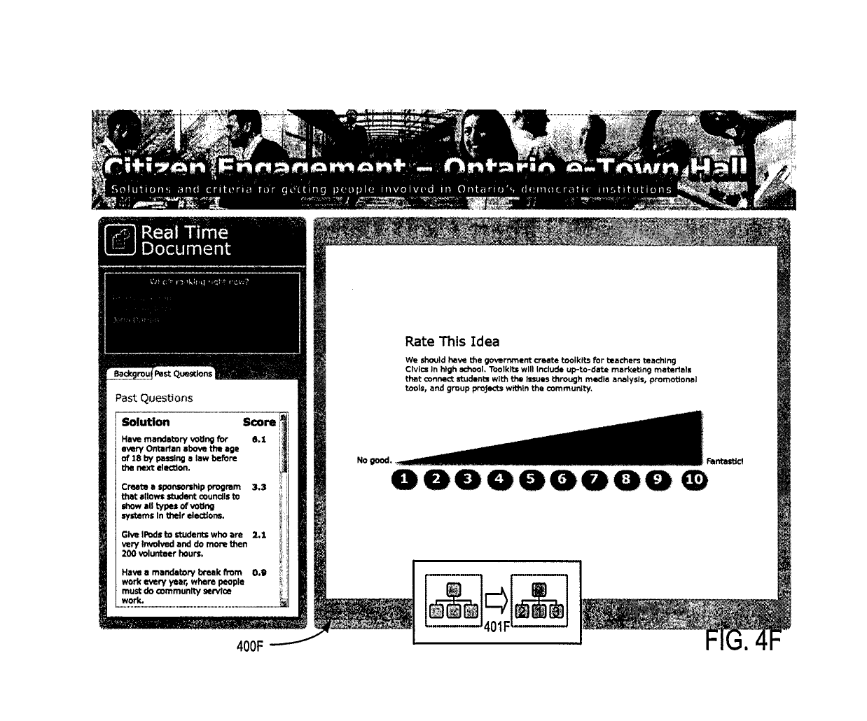

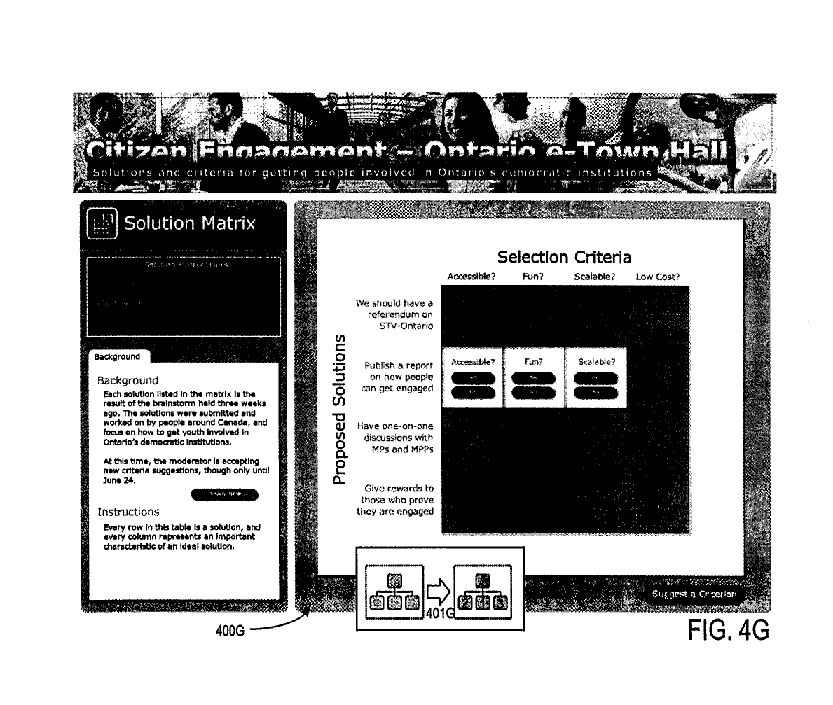

Shown in FIG. 4A is a sample screen capture 400A of an illustrative “brainstorm chat” tool interface. A corresponding transformation of the idea tree that may be effected by this brainstorm chat tool is represented graphically at 401A. This brainstorm chat tool may facilitate a brainstorming session by encouraging participants to submit new ideas about a problem or an issue being discussed.

When a brainstorm chat session begins, the corresponding brainstorm chat tool may be logically linked to an appropriate node in the idea tree that best represents the desired scope of the brainstorm. The node to which the tool is linked may semantically form the “topic” or “seed” for the discussion/brainstorm. In addition to submitting comments on ideas offered by others, participants can also submit their own new ideas. These new ideas may be added to the idea tree as child nodes to a node to which the brainstorm chat tool is logically linked. This brainstorm chat tool could permit a group to brainstorm solutions to a problem, propose new initiatives, or suggest changes. Participants' contributions are thus used to build the idea tree and become part of the collective store of knowledge in the idea tree. As will be appreciated, after many participants have added their contributions, the number of opinions expressed about an idea may be large, perhaps numbering in the hundreds, or even thousands.

In an embodiment, every participant can promote an idea by supporting it (e.g., by clicking a button associated with the idea). The number of votes of confidence received for an idea may be tallied, so that the submitter of the idea can see how well the idea is accepted by other participants. The ranking of ideas is discussed in detail further below.

In terms of implementation, as an illustrative example, this brainstorm chat tool may be configured as a web-based online chat interface using IRC, or other instant messaging protocols. The brainstorm chat tool could also be extended to interfaces for mobile devices, such as SMS. This may allow for many different access points for participation. For example, a brainstorming session or event could be held over the course of a few days or weeks, and the public may be alerted via billboards, print media, radio or television to submit their suggestions for solving a problem by sending an e-mail to a certain address, or a text message to a certain phone number. A server may then add the ideas received to the idea tree on a website.

### (b) Categorizer Tool

Shown in FIG. 4B is a sample screen capture 400B of an illustrative categorizer tool interface. A corresponding transformation of the idea tree applied by the categorizer tool is shown at 401B. As shown, the categorizer tool may have the effect of changing the structure of the idea tree.

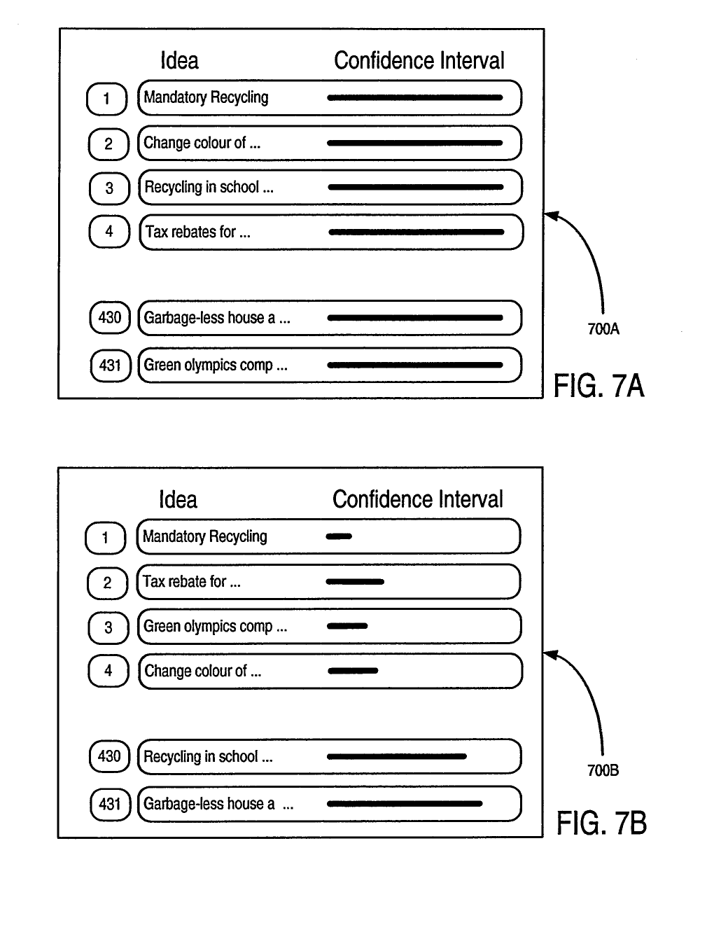

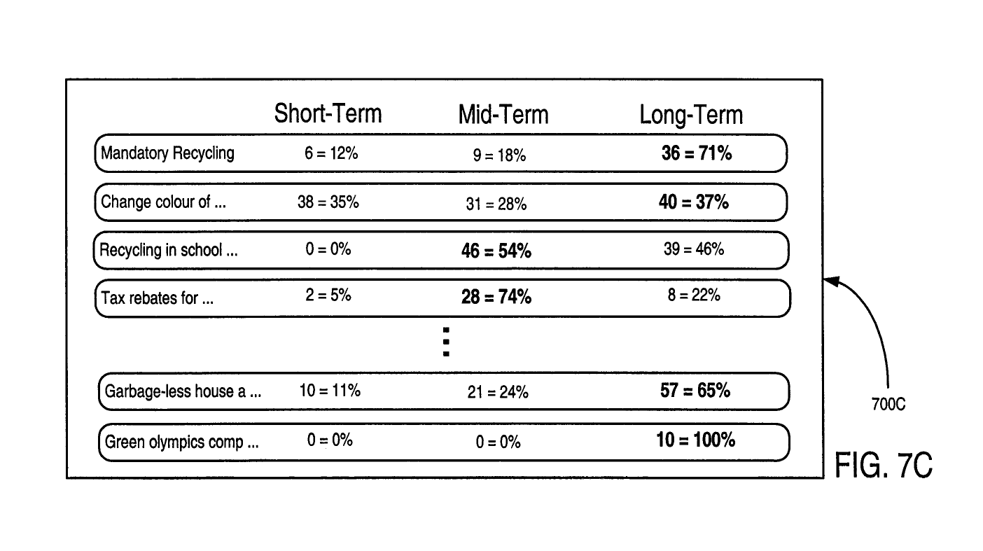

Ideas may come in all forms, and may cover a wide range of issues within a topic. A free-form public brainstorming session, such as may be facilitated using the brainstorm chat tool described above, could result in perhaps many hundreds or thousands of ideas. As noted earlier, the inventors propose a solution whereby each participant is asked to provide opinions on only a subset of questions that have been posed, these questions relating to opinions the participants may have on some of the ideas that have been generated by themselves, or by other participants. (An illustrative example of a categorizing operation will be described in more detail further below with respect to FIG. 7C.)

This categorizer tool may permit a group of participants to contribute to the task of categorizing a large collection of ideas. Each participant may be shown a relatively small number of ideas and asked to place them in categories based on their views of how the ideas are related. The preferred participant categorizations may be tabulated as votes, and based on a statistical model, other ideas may be presented to participants as they progress through the categorization operation. The inputs from the participants can then be aggregated such that the overall result of the categorization is statistically representative of the entire group. If a participant feels that none of the predefined categories fit, the participant may also submit a new category for review and possible inclusion by a moderator.

A moderator may set up operation of this categorizer tool by selecting the ideas to be categorized, and providing an initial list of possible categories. The categorizer tool may create new nodes that are populated with the categories, and may move the ideas under these category nodes according to the group's overall categorization preference, as statistically determined by their categorization choices.

Like the Brainstorm chat tool described above, the categorizer tool may be logically linked to a particular node. In this case, the categories may be inserted as child nodes to the link node, and any nodes being categorized may get moved under the category nodes as child nodes, as they are categorized by the group.

### (c) Collaborative Document Editing Tool

Shown in FIG. 4C is a sample screen capture 400C of a collaborative document editing tool. A corresponding transformation that may be applied to the idea tree by this tool is shown at 401C. This collaborative document editing tool may be used to access and search through a document, and to submit proposed changes and edits.

In an embodiment, while the proposed changes and edits may immediately be made available for viewing, a moderator may moderate the proposed changes and edits as may be necessary to maintain organization of the idea tree. Since this collaborative document editing tool may allow people to work on different parts of the idea tree asynchronously, it is highly scalable, and allows for a large number of participants to contribute to the idea tree at the same time. The only practical limitation may be the capacity of a moderator to review and approve proposed edits and changes if that is desired, although multiple moderators may be used in this case if the capacity so demands.

As with other tools in the collaboration toolkit, the collaborative document editing tool may be logically linked to a specific node and its child nodes, and access only the relevant collaborative document editing tool related data stored in the selected portion of the idea tree. The collaborative document editing tool may be configured to create or modify an appropriate text entry stored in each node, as the moderator accepts the comments made by participants.

In terms of implementation, in an illustrative Internet-based XML schema example, memo-type DataItems may be used to store free-form text in each node. In an embodiment, each node may be configured to contain the information necessary to adequately describe its semantic content. A tool can then assemble the text from each node to produce a document. If a collective ranking is associated with each text entry, the text may be presented in the produced document in a ranked order.

The document can be edited by participants, and the changes may subsequently be translated to a transformation of the idea tree. For example, changing a paragraph of text would modify the memo-text DataItem entry in the appropriate node. Also, reordering the text may update the relative ranking of the nodes.

This collaborative document editing tool permits multi-user manipulations of a document by automatically segmenting the document according to its underlying semantic structure, as specified by the idea tree.

### (d) Real-Time Collaborative Document Editing Tool

Shown in FIG. 4D is a sample screen capture 400D of a “real-time” documentation tool. A corresponding transformation that may be applied to an idea tree by this “real-time” documentation tool is shown at 401D. This real-time collaborative document editing tool is an alternative to the collaborative document editing tool, and may give participants the ability to work together and to coordinate each other's contributions to a document in real-time. Participants can either edit pre-existing files extracted from the idea tree, or start with nothing more than a document outline for a new document. Changes to the document may be tracked for each participant, and a chat room may be made available, allowing moderators and participants to coordinate their work in real-time.

As with the collaborative document editing tool, a moderator may derive an outline of the discussion by navigating the idea tree. Each paragraph or section of the document may be associated with an idea and exists as a node in the tree. Changes made to the document may be entered as edits in the appropriate records of tables in the appropriate nodes.

Since the tool allows participants to work in real-time on a specific document, it may be more effectively used on smaller parts of an idea tree, and larger collaborations may be better handled by the collaborative document editing tool.

### (e) Document Commenting Tool

Shown in FIG. 4E is a sample screen capture 400E of a document commenting tool. The corresponding transformation that may be applied by this tool to an idea tree is shown at 401E. This document commenting tool may allow participants to comment on a document as created by one of the document tools mentioned above, or imported from another source. As shown at 401E, these comments may be added, for example, as child nodes to a respective idea presented in a patent node.

This document commenting tool can be configured to select an entire idea tree, or to select a particular sub-tree in which a document has been created using one of the earlier mentioned document tools. The tables associated with each node of the idea tree may contain text entries that may be assembled as necessary to display a document. When a participant adds a comment to a paragraph using this document commenting tool, a new child node may be created under the node to which that paragraph belongs, and the comment may then be entered into a record of a table in the new child node.

As will be explained further below, other participants may have the option of ranking a comment added using the document commenting tool. This ranking information may be stored, for example, as entries in the table of node containing the comments. In this manner, moderators may be directed, for example, to deal with the most popular comments based on ranking by all of the participants.

Again, participants or the moderator may logically link the document commenting tool to a particular node, and direct their feedback to specific sections of a document. As noted at 401E, these comment nodes may be nodes in the general sense, and can become seeds for another brainstorm. The comments can also be processed by a ranking or categorization tool, or can be assembled into a new document which can in turn be commented on again, thereby creating an iterative process.

### (f) Ranking Tool

Shown in FIG. 4F is a sample screen capture 400F of a ranking tool which may be used to rank ideas within the idea tree. A corresponding transformation applied by this tool to an idea tree is shown at 401F. As explained further below, this ranking tool may be very useful for seeking opinions on a number of ideas from a large group of participants.

By way of example, participants may be asked to rate an idea on a numeric scale, or simply with an agree or disagree indication. The ranking tool may use as an input a collection of nodes that are siblings on the idea tree. Amongst the sibling nodes, the ranking tool can tabulate, for example, the relative rank of each sibling node. This relative rank information may be associated with a unique rank ID amongst the sibling nodes, so that relative rankings can be compared. The rank IDs may also be used to reconstitute the ranking of the nodes in the event that changes to the idea tree structure cause the nodes to no longer be siblings (i.e. the ranked nodes can be compared against each other using the results of a ranking operation even if the nodes are no longer siblings).

In an embodiment, participants can collaboratively create a ranking of a group of ideas or suggestions. The ranking tool may take as input a collection of nodes on the idea tree. One way of specifying this collection of nodes would be to link the ranking tool to a common parent, the child nodes of which form the input set. Each participant may then be presented with the ideas contained in the sibling nodes and asked to express an opinion (e.g. “Is this a good solution to the problem?” “Would you purchase this product?” or “Is this date convenient for you to hold a conference?”). Participants can then express their opinions on as many of the ideas as they may care to view, with the system aggregating the contributions of all participants to create a collective ranking of the ideas. (An illustrative example of a ranking operation will be described in more detail further below with respect to FIGS. 7A and 7B.)

The ranking may then be stored as a doubly-linked list in the data tables of all the nodes involved. As will be appreciated by those skilled in the art, in a doubly-linked list, each element in an ordered list contains a pointer to the next element and a pointer to the previous element. By traversing these pointers in both directions to the end of the chain, a set of nodes upon which such a ranking is performed may later be reconstructed. The ranking may also survive node deletion by updating the doubly-linked list as appropriate (i.e. the pointers in the nodes adjacent the deleted node are updated to reflect the deletion). This effectively removes a particular node from the list, but the relative ordering of all other nodes is retained. It will also be appreciated that a node can participate in more than one ranking, since each ranking operation simply adds a ranking entry to the node's data table. For example, one might want to know how Nodes A, B and C rank relative to each other, and then how Nodes B, D and E rank relative to each other. In this case, Node B may have two ranking entries, each with a rank ID and two pointers that form part of the doubly-linked list that defines the set of nodes upon which that particular rank was done.

### (g) Solution Matrix Tool

Shown in FIG. 4G is a sample screen capture 400G of a solution matrix tool. A corresponding transformation applied by this tool on an idea tree is shown at 401G.

This solution matrix tool may assist with the task of decision making by providing a set of criteria and a number of proposed solutions that may meet the criteria. The intersection between a particular solution (listed in rows), and a criterion (listed in columns), is where a participant may provide input on whether a particular solution has met certain criteria.

Participants may be able to see their own answers to these questions as they enter them (e.g. as shown by a check-mark or an x-mark). However, the solution matrix tool may be used to tabulate the collective results to see how many participants feel that a particular solution abides by specific criteria. Ideas that do not conform to a set of criteria may be deleted by a moderator, and the solution matrix tool may be used to showcase the preferred solutions.

The solution matrix tool may apply a similar transformation of the idea tree as the ranking tool. For example, the moderator may select the nodes to be rated and enter the criteria upon which participants should make their decisions. The moderator may also assign numerical weight values to each of the criteria to be used in computing the final rank. For each node, the solution matrix tool may store an aggregated rank, and how that idea did in each category.

### Moderator Tools

In addition to the participant collaboration tools described above, certain moderator tools may also be provided. For example, a spell check tool may allow the moderator to spell check the text in a selection of nodes (e.g. a node and all of its associated child nodes). The spell check tool may present spelling errors, suggests corrections, and receive instructions to correct or to ignore. The spell check tool may end after the moderator completes the spell check task, and updates the idea tree with the corrected text.

The moderator may also be provided with a tree editor tool to control the growth of the idea tree. For example, the moderator may wish to periodically prune the idea tree by eliminating branches of ideas that are outdated, or irrelevant to a discussion. The tree editor tool may also allow the moderator to view the idea tree, move or delete nodes, and save a modified version of the idea tree. All of these editing actions may be undone by backtracking each step, or by reverting back to a previously saved version of the idea tree.

The moderator may also be provided with management tools that may be used to keep track of activity summaries, participant lists, and access control lists. These management tools may provide the ability to query the activity summaries to examine the activities of various participants (for example, to determine who should be given which level of access). For example, the moderator may be given the authority to modify the access control list for a particular collaboration project, or for a particular collaborative tool.

### Sample Tool Workflows

To illustrate how different tools may be used to simulate a workflow having a sequential progression, some sample tool workflows are now described.

The first example is a large-scale collaboration for authoring a document addressing a particular project topic. Using the brainstorm chat tool, a group of participants may brainstorm the project topic, and possibly generate a number of sub-ideas that may be added to an idea tree as sub-nodes. Each sub-node in turn could be expanded upon until the idea tree has grown to include ideas and collaborative input from the participants.

Next, using a solution matrix tool, the ideas presented in the idea tree may be ranked by the participants, and poorly ranked ideas may be eliminated as may be appropriate. Participants may then be asked to comment on the pros and cons of the remaining solutions, as measured against a set of criteria.

Using the results of the solution matrix tool, a collaborative document editing tool could be used to create a document outline where each major sub-theme may be presented as a chapter, and each idea about the sub-theme may be presented as a section within each chapter. Introduction and conclusion sections may be added as well. The document may undergo amendments with participation from many participants. A moderator may play the role of an editor to control the growth of the document as may be appropriate.

As another illustrative example, a group troubleshooting project is now described. First, a group may start an online project where, using the brainstorm chat tool, members are encouraged to list problems. Using the categorizer tool, the problems may be categorized using group-recommended categories. Next, the ranking tool may be used to determine which of the problems are most pertinent for discussion by the group by collecting rankings from the participants. Less pertinent problems may be deleted, or left to be dealt with at a later time. Of the remaining problems, members may use the brainstorm chat tool to consider possible solutions to the problems identified as being the most pertinent. Once this process of proposing solutions is complete, the ranking tool may again be used to rank the solutions based on perceived effectiveness in dealing with a problem. Using the solution matrix tool, the best solution may be selected from a number of solutions presented, given their effectiveness in meeting defined criteria.

### The Toolkit Interface

In an Internet-based implementation, participants may be able to access the collaboration toolkit by going to a website that implements the toolkit and contains links to various projects. For example, the collaboration tools main page may have a list of all projects that may be accessed. The order of listing of projects on the webpage may be determined by popularity as measured by the amount of activity, i.e., more popular projects may be placed closer to the top of the listing. Projects in which the level of participant activity may have changed drastically could also be identified as being very active, and placed closer to the top of the listing. This may ensure that projects are appropriately rotated within the listing, based on the level of interest.

New projects can be created using a link on the main page. As an illustrative example, two options may be available for creating new projects: (i) the server can be set up so that anyone can create a project, or (ii) this option can be made available just to the moderator or to only a small number of participants, allowing for some control over the types of projects created. To create a new project, the moderator or participant may add basic project information, such as the project's name and purpose, and create a tentative schedule of workflow items. The project may then be made available on the main page.

Once a particular project is selected, the associated project page may be the starting point for getting involved in the project. This project page may be used to access a particular collaborative tool (e.g. one of the tools as described earlier), as made available by the moderator. The project page may also contain summaries of any work already completed on the project using other collaboration tools. Participants can add themselves as contributors to the project, which may result in their “handle” being placed on a list of participants on the project page.

Each tool may be configured as a client process that is unique to the specific tool, allowing participants to interact with the tool and with other participants. Tools may be configured to create summary documents that summarize the actions of participants, and the transformations applied to the idea tree using the tools. For example, a document creation tool might present the document, a categorizer tool may show the final categorization, and a ranking tool would show the final rankings of the ideas.

Each participant may be provided with a personal profile. Wherever a participant's name is shown, a click on the name (e.g. using a mouse) may display the activity log for all projects that the participant has contributed to. The personal profile for each participant may also contain a personal description space, where the user can post a short personal description. Additional profile items can be set up by the server administrator.

If a participant wishes to make his or her contributions anonymously, they may do so by modifying their personal settings. Anonymous contributions may be labelled as being anonymous within project archives. If deemed necessary to avoid an undesired skew in the results from too many anonymous participants with a particular view, a project moderator may decide to disallow anonymous contributions in some or all portions of a project. In this case, if a participant has chosen to remain anonymous, a tool could either block their contributions, or ask if the user is willing to forfeit their anonymity in order to access and participate in the project or tool in question.

To assist the moderator, a wizard tool may be provided which asks a number of appropriate questions. For example, the wizard may ask a series of “What do you want to do next?” questions. These questions may focus on finding out what a moderator wishes to do, and helping him or her choose the proper tool or set of tools to meet their goals. A moderator may then choose which portion of the idea tree to use as data for a particular tool, and link the tool to the appropriate node accordingly. Tool-specific wizards may also be provided which may help in ensuring that a moderator chooses the proper tool settings.

### IT Architecture

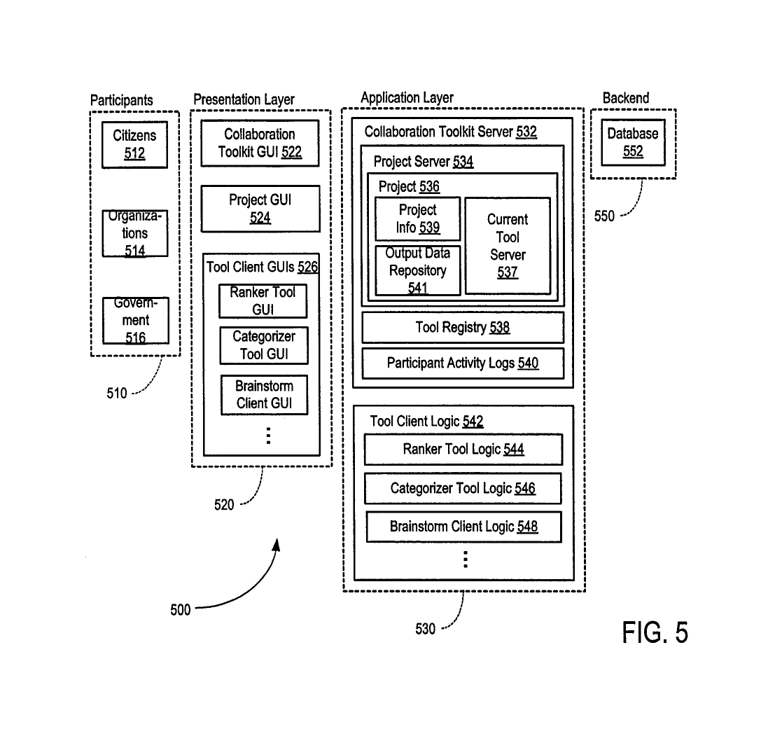

An illustrative architectural overview of the collaboration toolkit is shown in FIG. 5. As previously mentioned, this IT architecture may be embodied in suitably configured data processing systems (e.g. data processing system 100 of FIG. 1), and associated communications networks, devices, software and firmware.

As shown in FIG. 5, the collaboration toolkit may comprise a presentation layer 520 and an application layer 530 positioned between participants 510 (e.g. citizens 512, organizations 514, government 516), and a back-end 550 (containing database 552). The presentation layer 520 may be designed, for example, using IBM's Websphere™ Portal Server. The application layer 530 responsible for the business logic may be designed, for example, on IBM's Websphere™ Application Server. For the back-end 550, IBM's DB2™ Information Management Software may be used as the database 552. The presentation layer 520 and application layer 530 may use web services to communicate, and the application layer 530 may communicate with the back-end database 552 using an appropriate protocol, such as the Java™ DataBase Connectivity (“JDBC”) protocol for example.

At the presentation layer 520, graphical user interfaces may be provided for each of the components of the application layer, including a collaboration toolkit GUI 522, a project GUI 524, and various tool GUIs 526.

The presentation layer 520 is responsible for all elements related directly to the participants 510. It may consists of a number of components, including a collaboration toolkit GUI 522, a project GUI 524, and tool client GUIs 526. The collaboration toolkit GUI 522 provides all interface and presentation elements of the collaboration toolkit server 532 and the project GUI 524 provides all interface and presentation elements of the project servers 534 as described below. The tool client GUIs 526 provide all interface elements for their corresponding tool clients (544, 546, etc.) as instantiated on the project's tool servers (537).

By way of example, the collaboration toolkit GUI 522 may consist of a number of J2EE™ (Java 2 Platform, Enterprise Edition) portlets that could be deployed on IBM's Websphere™ Portal Server platform. Tool client GUIs 526 may also be designed as portlets. Depending on the tool, the interface may either be designed as HTML (HyperText Markup Language), or as an encapsulated Java Applet.

The application layer 530 may consist of a number of components, including: (i) a collaboration toolkit server 532; (ii) a project server 534; (iii) one or more tool servers 537; and (iv) tool server logic library 542. Generally speaking, a tool server 537 may be an instantiation of a tool server logic (i.e. one of 544, 546, etc.), which is the general server-side software needed to support the functionality of a particular collaborative tool (brainstorm chat tool, ranking tool, etc.). When a moderator selects a tool to use in the project, that tool's server logic is instantiated into a tool server 537. The tool server logic library 542 acts as a repository from which server-side software can be loaded as needed by a project. As described above, there can be more than one tool server 537 active in a project at the same time, each tool server 537 running the same or different tool server logic. For example, two tool servers 537 may run two brainstorm chat tools working on different nodes in the idea tree, or two tool servers 537 may run a brainstorm chat tool and a ranking tool concurrently. The collaboration toolkit server 532 may contain a wide variety of different project servers 534, each corresponding to a different project 536 utilizing the toolkit. Project Servers 534 are described in more detail below.

The collaboration toolkit server 532 may also include a tool registry 538 of all tools that are currently available. This tool registry 538 may store, for example, the location of the tool server logic (544, 546, etc.) in the tool server logic library 542, the location of the matching tool client GUI in 526, and an associated tool wizard (not shown). The collaboration toolkit server 532 may also store a log of activity for each participant in participant activity logs 540, detailing how a participant has interacted throughout the different projects 536 on the various project servers 534.

Each project server 534 may contain the project information and business logic for a single project. Each project server 534 may store important information about the project 539, including the schedule of tools that have been used in the past, the schedule of tools to be used in the future, and various properties of the project. An output data repository 541 may store information outputted by each individual tool.

Each tool server 537 may have a number of outputs, for example: (i) an output tree after all transformations have been performed; (ii) an HTML output providing a visual representation of the output for participants to see what was accomplished; and (iii) a participant log to update individual user profile pages and participant activity logs 540.

Each tool client's logic (544, 546, etc.) may contain all of the business logic related to an individual tool's operation. As shown, the tool server logic library 542 may include logic for various tools, including a ranker tool logic 544, categorizer tool logic 546, brainstorm client logic 548, etc. For example, in the brainstorm chat tool, this tool server logic 548 would describe the transfer of information between a tool server 537 and a tool GUI running on the presentation layer 520, the storing of messages and idea data, and other server-side processing.

When a moderator starts a new tool in a project 536, a new tool server 537 is created and the chosen tool's server logic (544, 546, etc.) is loaded from the tool server logic library 542. A participant 510 accesses the website by logging in through the collaboration toolkit GUI 522 (which is connected to the collaboration toolkit server 532). The participant 510 then chooses a project 536 to access. The collaboration toolkit GUI 522 then loads the project GUI 524 which connects to the appropriate project server 534. The project server 534 verifies that the user has the appropriate privileges to access the project. The participant 510 uses the project GUI 524 to navigate the various information areas of the project and may eventually select to participate in one of the active collaborative tools. The project GUI 524 inquires about the tool on the appropriate tool server 537, looks up the tool in the tool registry 538 and loads the appropriate tool client GUI 526. The tool client GUI 526 connects to the appropriate tool server 537. The user can then interact with the tool via the tool client GUI.

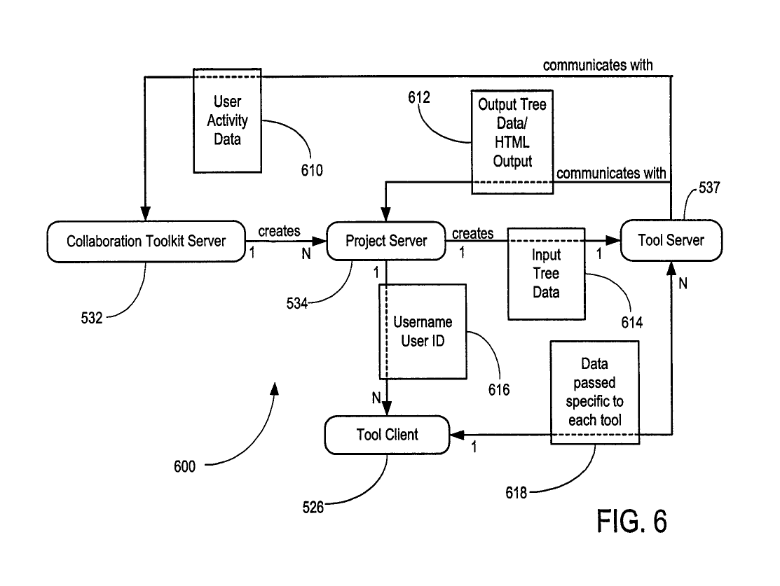

An illustrative flow of communication between various components of FIG. 5 is shown in FIG. 6. At regular intervals, a tool server 537 communicates with a project server 534 and sends output tree data and HTML formatted output 612 to the project server 534. The tool client 537 also sends user activity data 610 to a collaboration toolkit server 532.

The collaboration toolkit server 532 may create one or more project servers 534. The project server 534 may initiate one or more tool servers 537, providing the tool servers 537 with input tree data 614. Project server 534 may also provide the username and user ID 616 of the participant to a tool client GUI 526. The tool client GUI 526 may then access the tool server 537. The tool client GUI 526 communicates with the tool server 537, at 618, in a manner specific to each tool.

It will be appreciated that the communication flow in FIG. 6 is illustrative, and that other communication flows may be possible.

### Aggregation of Subsets of Opinion

Certain aspects of the present invention will now be described in more detail. In an embodiment, each participant may be asked to answer a small subset of questions, where each subset of questions may be different from a subset of questions posed to another participant. For each question, a participant may be asked to respond with a numeric value within a fixed range (e.g. as shown by illustration in FIG. 4F, above). The responses may be mapped to an aggregate numeric value, whether it is an average of selected values, or in the case of yes or no answers, a tally of yes responses versus no responses.

For a given question, the mean value of all responses is of particular interest, as this may be considered to be the collective opinion of a group of participants. If the participants to which a particular question is posed are randomly selected, the chance of a systematic bias in the mean may be reduced. This may also permit the assumption that the sample of responses for any question is likely to be normally distributed about the true population mean.

The number of participants to which a question must be posed, before the mean of the responses can be taken as a satisfactory estimator of the mean of the population's opinion, may be calculated using the confidence interval of the mean of the sample of responses. A fixed confidence level of say 95% may be used in calculating the confidence intervals.

As a participant answers a question, the response may be added to that question's list of responses, and a new confidence interval for the mean of those responses may be calculated. The participant may then be offered another question that the participant has not answered before, and that currently has one of the widest confidence intervals about its mean (indicating a wide variation in participant responses). Where there is a tie among questions having the largest confidence intervals, the next question may be selected randomly from among these questions.

After a number of participants have provided an opinion or ranking, questions that return responses within a narrow range may achieve a narrow confidence interval early on, and may not need to be asked again very often. On the other hand, questions that elicit a wide range of responses from the participants may need to be posed to many more participants, with the intent of trying to narrow the confidence interval. As the number of participants and responses rise, the confidence intervals of all questions in the pool may become progressively narrower. Questions can be posed more often or less often, until sufficiently narrow confidence intervals for the means of responses to the questions have been attained.

By presenting a customized subset of the questions to each participant, the potential for biased results stemming from the order, grouping or other psychological interactions between questions may be reduced. For example, participants may be more likely to answer ‘yes’ to a question on diversity after they are asked if they have any friends who are members of visible minorities, than if they had not been previously asked such a question. The randomized nature of the subset of questions may reduce the likelihood of bias by placing potentially related questions in a different order for some respondents, or not presenting those questions at all to other respondents.

In an embodiment, one could use the teachings of the present invention to create a ranked list of ideas where the list is extremely long, to determine which ideas appear to be most highly supported by the group. In this case, the poll may consist of a series of questions that have the form “What do you think of this idea: [insert idea here]?” An interim ranking of ideas may be maintained in real-time as respondents are submitting their opinions. Ideas may be selected to be put to respondents based on the confidence intervals, as described above, with an adjustment factor for where in the ranking the idea currently resides based on the participants' prior responses. In this way, the system can be weighted to extract the most accurate information about either the top or bottom of the rank.

As an illustrative example, a group collaboration may have generated 1,000 ideas for implementing a recycling program. One may wish to find the top four ideas based on the feedback of users. As described above, a participant may be provided with a subset of the 1,000 ideas, and asked to rate each idea between 1 and 10, where 1 is “no good” and 10 is “fantastic” (e.g. as per FIG. 4F).

As shown in FIG. 7A, the system may start with a random ordering of the ideas, each idea having the maximum possible confidence interval. As ideas are served up to various participants, their rankings in the list may change based on the participants' responses, and their confidence intervals may shrink correspondingly. (Note that the ideas in the list would be ranked according to the participants' responses, and not according to the respective confidence intervals.) The system may then select the next idea(s) to be presented to the participant based on which of the ideas have the widest confidence intervals.

Alternatively, if it is desired to arrive faster at a number of top ideas from the list, the selection of ideas presented to participants may be skewed in favour of those ideas that seem to be emerging as the leaders. This may cause ideas currently high up on the list to be submitted to respondents more often than they would be otherwise, had the selection been based solely on confidence intervals. In this case, the end result is a ranked list of ideas in which the top ideas are more likely to be representative of the top ideas of the group collectively, as they have received opinions from more participants. It may be less likely that the ideas towards the bottom of the list are ranked correctly, since they may be submitted to respondents less often, in a trade-off that may help reduce the amount of time required to arrive at a ranking of the top few ideas.

The scenario described could also work in reverse if, for example, it is desired to find the 50 worst ideas to be eliminated from the list. In this case, the system may select subsequent questions for respondents based on confidence intervals, but skewing in favour of those ideas that are emerging as the worst. In that case, the confidence intervals of the resultant list would shrink towards the bottom of the list. Ideas that drift towards the bottom after a few responses may be served up to more participants to ensure that these are, in fact, the worst ideas.

In another embodiment, instead of having a large number of participants rank a large list of ideas, the teachings of the present invention may be extended to having a large number of participants categorize an idea. To illustrate this point, the following example considers categorizing ideas for encouraging recycling. In this scenario, opinions on a subset of ideas may be sought from participants by posing a series of questions that have the form “In which category do you think this idea most belongs: [insert idea here]?”

Each participant may be permitted to place each idea in one of a fixed set of categories. The system may then register a ‘vote’ in favour of placing that idea in that category. The final categorization emerges by placing each idea in the category for which it received the most votes.

As illustrated in FIG. 7C, the group seeking to encourage recycling may need to make three recommendations to the city council: a short-term recommendation (a plan that can be implemented in a 6-month time-period); a mid-term recommendation (a plan requiring 6-18 months); and a long-term recommendation (a plan requiring more than 18 months to implement). Not having the resources to properly research each of these ideas, the group may pose the problem to the community, and asks participants who may know something about these ideas to help place them in one of the three categories.

Since a gradient of responses does not exist here, a confidence interval is not applicable. However, in place of a confidence interval, one can examine the relative polarization of votes. In an embodiment, the system may select subsequent ideas to put before a participant based on which ideas have the lowest percentage vote in the winning category (“PVWC”). The lowest PVWC is directly the percentage of votes an idea has in its ‘winning’ category. For example, if idea X has so far received 20% of its votes for category A and 70% for category B and 10% for category C, its PVWC is 70%. Idea Y may have 40% of its votes for category A, 40% for category B, and 20% for category C. In this case, idea Y has a PVWC of 40%. According to this ranking scheme, the system would prefer to put idea Y before a respondent as it has the lowest PVWC, and therefore an additional response to this categorization question would contribute the most to the overall poll.

Referring to the illustrative example shown in FIG. 7C, the PVWC for each idea is the percentage shown in bold. Therefore, the next idea preferred to be put before a new respondent who had not yet categorized any ideas would be the second one, “Change colour of . . . ” This is the idea whose categorization is most ambiguous, and therefore additional input is needed.

The selection of ideas based on PVWC would commence after each question had received a pre-set number of votes (i.e. 10 in the above example). This may ensure that the PVWC value is more likely to be reflective of the opinion of the group. Prior to using the PVWC, ideas may be served to respondents randomly.

While various illustrative embodiments of the invention have been described above, it will be appreciated by those skilled in the art that variations and modifications may be made. More generally, the illustrative embodiments and operating environments described above are not meant to be limiting, and the scope of the invention is thus defined by the following claims.

What is claimed is:

1. A method of aggregating opinions on questions from a plurality of participants, said method comprising:
a processor of a data processing system receiving from each participant, for each question of a plurality of questions previously presented to each participant, a selection, from a plurality of categories, of a category into which each participant has placed an idea associated with each question, said plurality of categories comprising said selected categories;
said processor calculating a percentage vote for each selected category of each idea, said calculated percentage vote for each selected category of each idea being a percent of participants that selected each category of each idea;
said processor selecting a winning category for each idea, based on the calculated percentage vote for each selected category of each idea;
said processor determining a next idea consisting of the idea having the lowest calculated percentage vote of the ideas's winning category; and
said processor determining a next question associated with the next idea having the lowest calculated percentage vote of the ideas's winning category; and
in response to said determining the next question, said processor presenting the next question to a new participant not comprised by the plurality of participants.

2. The method of claim 1, said method further comprising:
in further response to said determining the next question, said processor presenting an identification of the next idea such that the next question directs the new participant to select a next category of the plurality of categories for placement of the next idea and in response, receiving the new participant's selection, from the plurality of categories, of the category into which new participant has placed the next idea.

3. The method of claim 1, said method further comprising:
prior to said receiving from each participant the selection of a category from the plurality of categories, said processor presenting, to each participant, questions and an identification of an idea associated with each presented question such that each presented question directs each participant to select the category of the plurality of categories for placement of the identified idea, said questions presented to each participant being selected from the plurality of questions.

4. The method of claim 1, wherein each category is a different idea with respect to the question.

5. A data processor readable storage medium having a computer readable program code stored therein, said computer readable program code configured to be executed by a processor of a data processing system to implement a method of aggregating opinions on questions from a plurality of participants, said method comprising:
sad processor receiving from each participant, for each question of a plurality of questions previously presented to each participant, a selection, from a plurality of categories, of a category into which each participant has placed an idea associated with each question, said plurality of categories comprising said selected categories;
said processor calculating a percentage vote for each selected category of each idea, said calculated percentage vote for each selected category of each idea being a percent of participants that selected each category of each idea;
said processor selecting a winning category for each idea, based on the calculated percentage vote for each selected category of each idea;
said processor determining a next idea consisting of the idea having the lowest calculated percentage vote of the ideas's winning category; and
said processor determining a next question associated with the next idea having the lowest calculated percentage vote of the ideas's winning category; and
in response to said determining the next question, said processor presenting the next question to a new participant not comprised by the plurality of participants.

6. The storage medium of claim 5, said method further comprising:
in further response to said determining the next question, said processor presenting an identification of the next idea such that the next question directs the new participant to select a next category of the plurality of categories for placement of the next idea and in response, receiving the new participant's selection, from the plurality of categories, of the category into which new participant has placed the next idea.

7. The storage medium of claim 5, said method further comprising:
prior to said receiving from each participant the selection of a category from the plurality of categories, said processor presenting, to each participant, questions and an identification of an idea associated with each presented question such that each presented question directs each participant to select the category of the plurality of categories for placement of the identified idea, said questions presented to each participant being selected from the plurality of questions.

8. The storage medium of claim 5, wherein each category is a different idea with respect to the question.

9. A data processing system comprising a processor and a data processor readable memory unit coupled to the processor, said memory unit containing program code configured to be executed by the processor to implement a method of aggregating opinions on questions from a plurality of participants, said method comprising:
said processor receiving from each participant, for each question of a plurality of questions previously presented to each participant, a selection, from a plurality of categories, of a category into which each participant has placed an idea associated with each question, said plurality of categories comprising said selected categories;
said processor calculating a percentage vote for each selected category of each idea, said calculated percentage vote for each selected category of each idea being a percent of participants that selected each category of each idea;
said processor selecting a winning category for each idea, based on the calculated percentage vote for each selected category of each idea;
said processor determining a next idea consisting of the idea having the lowest calculated percentage vote of the ideas's winning category; and
said processor determining a next question associated with the next idea having the lowest calculated percentage vote of the ideas's winning category; and
in response to said determining the next question, said processor presenting the next question to a new participant not comprised by the plurality of participants.

10. The data processing system of claim 9, said method further comprising:
in further response to said determining the next question, said processor presenting an identification of the next idea such that the next question directs the new participant to select a next category of the plurality of categories for placement of the next idea and in response, receiving the new participant's selection, from the plurality of categories, of the category into which new participant has placed the next idea.

11. The data processing system of claim 9, said method further comprising:
prior to said receiving from each participant the selection of a category from the plurality of categories, said processor presenting, to each participant, questions and an identification of an idea associated with each presented question such that each presented question directs each participant to select the category of the plurality of categories for placement of the identified idea, said questions presented to each participant being selected from the plurality of questions.

12. The data processing system of claim 9, wherein each category is a different idea with respect to the question.
